(19) United States
(12) Patent Application Publication
(10) Pub. No.: US 2026/0141277 A1
(43) Pub. Date: May 21, 2026

(54) METHOD OF EXPLAINING A SOLUTION OF A DECLARATIVE PROBLEM ENCODING

(71) Applicant: Robert Bosch GmbH, Stuttgart (DE)

(72) Inventors: Tobias Geibinger, Wien (AT); Johannes Oetsch, Wien (AT); Tobias Kaminski, Armsheim (DE)

(21) Appl. No.: 19/389,472

(22) Filed: Nov. 14, 2025

(30) Foreign Application Priority Data
Nov. 18, 2024 (DE) 10 2024 211 051.5

(51) Int. Cl. G06N 5/045; G06F 16/332; G06F 16/3329; G06N 20/00; G06Q 10/0631

(52) U.S. Cl. CPC G06N 5/045; G06F 16/3326; G06F 16/3329; G06N 20/00; G06Q 10/0631

(57) ABSTRACT

A computer-implemented method of explaining a solution of a declarative problem encoding. The solution and a natural language question about the latter are provided to a machine learning system, which determines auxiliary constraints 21 opposing the questions premise. The declarative problem solver identifies conflicts between these auxiliary constraints and the constraints of the declarative problem encoding. The machine learning system then determines an explanation based on the conflicting constraints of the declarative problem encoding.

### CROSS REFERENCE

The present application claims the benefit under 35 U.S.C. § 119 of Germany Patent Application No. DE 10 2024 211 051.5 filed on Nov. 18, 2024, which is expressly incorporated herein by reference in its entirety.

### FIELD

The present invention relates to a computer implemented method of determining an explanation for a solution of a declarative problem encoding, a corresponding system, a computer program, and a machine-readable storage medium.

### BACKGROUND INFORMATION

Constraint Programming and, particularly, Answer Set Programming (ASP) are powerful tools for declarative problem solving. Specifically, ASP is a declarative programming paradigm used for solving logic-based problems by finding stable models (answer sets) that satisfy a given set of rules and constraints. Generally, explaining solutions of declarative problem encodings and ASP programs is crucial for their wider adoption.

Existing approaches like xclingo use annotated rules to generate explanations for ASP answer sets, while clingo-explaid focuses on explaining unsatisfiability by identifying relaxable constraints.

In doi.org/10.1007/978-3-031-43619-2_6, it has been argued that contrastive explanations, i.e., explanations answering/explaining why one outcome occurred instead of another, may be more appropriate explanations, easier to understand by a user.

### SUMMARY

According to a first aspect, the present invention relates to a computer-implemented method of determining an explanation for a solution of a declarative problem encoding. The solution of the declarative problem encoding shall be determined by a declarative problem solver and the declarative problem encoding may, in particular, comprise several constraints. According to an example embodiment of the present invention, the method comprises the following steps. In a method step, the solution and a natural language question regarding the presence or absence of elements within the solution is provided to a machine learning system. Preferably, the machine learning system is a large language model (LLM). An LLM is a type of artificial neural network trained on an extensive text dataset, enabling it to generate and process text and perform various language-related tasks. An element of the solution may be a particular variable assignment that satisfies all constraints. The machine learning system is configured to receive an input text and to determine an output text based on the input text. The input and/or output text of the machine learning system may be a natural language text. However, instead or in addition to a natural language text, the machine learning system may receive as an input text and/or may determine as an output text a text in a formal language and/or a computer code. In a next method step, the machine learning system determines auxiliary constraints that enforce a condition contrary to the premise of the natural language question. In this context, the machine learning system may receive a prompt that guides the machine learning system to determine the auxiliary constraints. A prompt may be understood throughout as an input to the machine learning system, that is designed to generate a specific (type of) output response of the machine learning system or to guide its behavior. Subsequently, the declarative problem solver determines at least one minimal violated set of constraints of the declarative problem encoding based on the declarative problem encoding combined with the auxiliary constraints. In other words, the declarative problem solver determines at least one minimal violated set of constraints from the original declarative problem encoding by combining the original declarative problem encoding with the auxiliary constraints and identifying conflicts within the combined set; in combining the declarative problem encoding with the auxiliary constraints, the auxiliary constraints are added to the declarative problem encoding. Thereby, the at least one minimal violated set is inconsistent/in contradiction/cannot be simultaneously satisfied together with the auxiliary constraints. In other words, the declarative problem solver identifies, based on the (original) encoding and the added auxiliary constraints, at least one minimal set of conflicting constraints from the original encoding. This minimal set is unsatisfiable when considered alongside the auxiliary constraints. In a subsequent method step, the machine learning system determines an explanation text that constitutes the explanation for the solution based on the at least one minimal violated set.

A declarative problem encoding may, in the context of this disclosure, be understood as a formal representation of a combinatorial problem as a set of variables, their possible values (domains), and constraints that restrict the combinations of values these variables can take. The goal of a declarative problem encoding is to find a solution that satisfies all constraints. In declarative problem solving, the domain of a variable may be the set of all possible values that the variable can be assigned.

An explanation of a solution may be understood to be a natural language description of why a particular solution takes its form, based on the identified minimal violated set, by explaining which constraints of the declarative problem encoding prevent alternative solutions satisfying the counterfactual premise of the input question.

According to an example embodiment of the present invention, the declarative problem encoding may be an answer set programming (ASP) program comprising facts, constraints, and rules. In this case, the solution is an answer set, and the declarative problem solver is an ASP solver. An element of a solution, i.e., an answer set, may then be an atom, wherein an atom is a basic logical fact or proposition that can be either true or false. It may represent a property or relationship between entities.

Advantageously, the method of the present invention is not limited to a particular declarative problem solving formalism or machine learning system and may be applied to various declarative problem solving formalisms and/or machine learning systems.

Advantageously, the provided method of the present invention facilitates more flexible and understandable question input and answer output, improving user interaction. In particular, the question may be formulated in natural language text, and it is not mandatory to understand and/or to input the formal language used in/underlying the formulation of the declarative problem encoding.

According to an example embodiment of the present invention, preferably, the machine learning system may be, in addition to the solution and the natural language question, provided with an example natural language question and corresponding example constraints that enforce a condition contrary to the premise of the example natural language question. In addition, optionally, the machine learning system may be further provided with the declarative problem encoding, or parts of the declarative problem encoding related to the natural language question, which may provide further contextual information to the machine learning system. An optimal additional input to the machine learning system may be found by prompt engineering, wherein prompt engineering may be understood as the process of constructing effective inputs (prompts) for the machine learning system to guide it towards a desired output.

Preferably, the natural language question provided may either ask
a) why a first set of elements is present in the solution; or
b) why a second set of elements is not present in the solution; or
c) why a first subset of elements is present in the solution in contrast to a second subset of elements not present.

In the aforementioned case, preferably, the auxiliary constraints either constrain
a) the first set of elements not to be present; or
b) the second set of elements to be present; or
c) the first subset of elements not to be present and the second subset of elements to be present in a solution of the declarative problem encoding with the auxiliary constraints added.

Advantageously, this allows users to pose complex “why” questions about a solution, encompassing both the presence and absence of specific elements, leading to more nuanced explanations. Particularly, in case of questions and auxiliary constraints of the type c) above, the contrastive nature (subset of elements present in contrast to another subset of elements absent in the solution) allows to (significantly) limit the number of constraints relevant for the explanation of a solution and accompanying question. In this case, this may be achieved by (implicitly, in course of the method steps) considering an intersection of the original and auxiliary constraints thereby reducing the number of constraints needed for the explanation. This may lead to more concise, yet insightful explanations, which may be easier to access and which may be easier understandable to a user.

According to an example embodiment of the present invention, preferably, the machine learning system may determine the explanation text in natural language, in controlled natural language, or in a predefined template language. Preferably, the machine learning may be prompted (i.e., be provided with a prompt, the prompt requesting the machine learning system) to determine the explanation text in the respective language. A prompt may be understood as an input text provided to the machine learning system that guides the machine learning system's text generation or behavior. Guiding, in the context of prompts and large language models, may be understood as directing the model's output towards a desired outcome or topic, shaping the model's response. Optionally, the prompt may include example input-output pairs guiding the machine learning system towards a desired output format, style, or content.

Natural language may be understood as everyday human language, characterized by flexibility, wherein controlled natural language may be a subset of natural language with restricted grammar and vocabulary. Controlled natural language may reduce ambiguity and improve computer processing. A predefined template language may be obtained based on filling predefined templates with specific values or phrases, offering limited flexibility but ensuring structured output.

Advantageously, this offers flexible output formats, supporting natural language, controlled natural language, or template-based explanations, which may be chosen according to diverse downstream applications.

According to an example embodiment of the present invention, preferably, if the declarative problem solver determines more than one minimal violated set, the machine learning system may determine an explanation for each of the minimal violated sets, and the method may further comprise a step of storing user selections of preferred explanations and the corresponding minimal violated sets in a memory. In addition, in a further step, similar explanations may be prioritized in future iterations by using the stored selections as additional training data for the machine learning system. For instance, the machine learning system may then be fine-tuned with the additional training data. Alternatively, the additional training data may be used as additional input to the machine learning system and the machine learning system may be prompted to prioritize alike explanations and minimal violated sets.

In context of the above-described additional method steps, prioritizing may imply giving an explanation (and the corresponding conflicting constraint out of the declarative problem encoding) a higher rank in a list of possible explanations presented to a user. The list of explanations may be presented to the user on a user interface, e.g., a computer monitor.

In other words, if the declarative problem solver finds multiple minimal violated sets, the machine learning system generates an explanation for each. User-selected preferred explanations and corresponding minimal violated sets are stored, preferably in a local or cloud storage, remote sever or database. These selections are then used as additional training data to prioritize similar explanations in future iterations, presenting the ranked explanations to the user.

Advantageously, this allows the machine learning system to learn user preferences and improve explanation quality over time.

According to an example embodiment of the present invention, preferably, the declarative problem encoding represents a product configuration problem or a task planning problem for the manufacturing and/or assembly of a product. Particularly, a product may be (alternatively: may be part of) a vehicle, a robot, a household machine, an electronic component, or an electronic device. Specifically, a product may, e.g., be an electric motor. For instance, a product configuration problem may involve selecting valid combinations of components meeting, optionally, specific requirements, with the goal of creating a customized (at least according to the specific requirements) product. For example, configuring an electric motor might involve choosing voltage, power, RPM, shaft type, and mounting style, while ensuring compatibility of the components and satisfying performance constraints.

A task planning problem in manufacturing may involve determining the sequence of operations, resource allocation, and scheduling required to produce a product. In other words, this may be production planning for a specific product or for the assembly of several components to a product. For instance, for an electric motor, possible steps in task planning may comprise at least one of the steps winding the stator, machining the rotor, assembling components, and testing the final product. As possible requirements or additional constraints in task planning problems in manufacturing, it may be generally foreseen to optimize for efficiency and minimize production time.

According to an example embodiment of the present invention, preferably, several solutions of the declarative problem encoding are determined, wherein the solutions represent valid product configurations, or sequences of actions in the manufacturing or assembly of the product. The method may then further comprise the step of determining, based on the solution selected by a user, control signal data of a machine or manufacturing line. In this context, the machine or manufacturing line may be configured for manufacturing/assembling of the product. In an additional method step, the product may be manufactured/assembled based on the determined control signal data. For manufacturing/assembling, robots may be used and the actuators of these robots may be controlled by the determined control signal data.

In other words, multiple valid product configurations or manufacturing/assembly plans may be generated. Upon user selection of a solution, corresponding control signals may be generated for the production machinery, enabling automated manufacturing/assembly, potentially using robots guided by these signals.

Advantageously, this facilitates direct translation of the chosen solution into physical production.

According to a further aspect, the present invention relates to a data processing system comprising a processor configured to perform a method of the present invention as described herein.

According to a further aspect, the present invention relates to a computer program comprising machine-readable instructions, which, when the program is executed by a computer, cause the computer to carry out one of the computer-implemented methods described above and below. Furthermore, according to another aspect, the present invention relates to a machine-readable storage medium, on which the above computer program is stored.

Example embodiments of the present invention will be discussed with reference to the figures in more detail.

### BRIEF DESCRIPTION OF THE DRAWINGS

FIG. 1 shows a flow chart of an exemplary embodiment of the present invention.

FIG. 2 shows a flow chart of an exemplary embodiment of the present invention.

### DETAILED DESCRIPTION OF EXAMPLE EMBODIMENTS

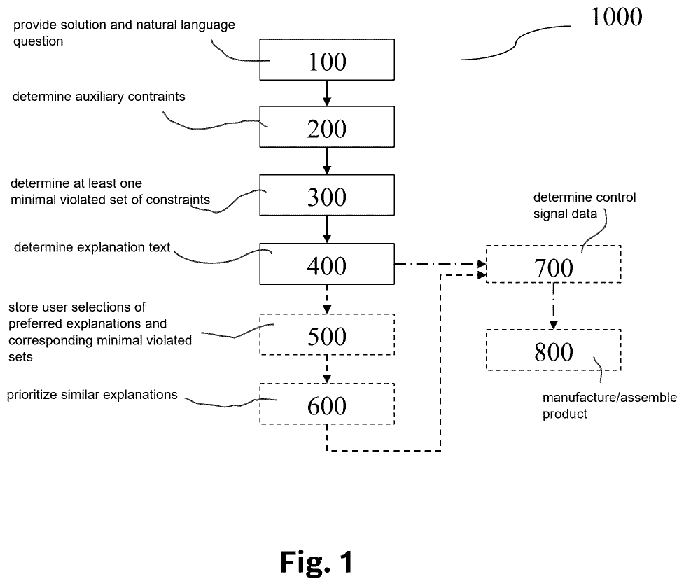

FIG. 1 shows an exemplary embodiment of a method of determining an explanation for a solution of a declarative problem encoding. The solution is determined by a declarative problem solver and, generally, the declarative problem encoding comprises constraints. In method step 100, the solution and a natural language question regarding the presence or absence of elements within the solution are provided to a machine learning system. The machine learning system may be a large language model, receiving input text and determining output text based on the input text. In step 200, auxiliary constraints that enforce a condition contrary to the premise of the natural language question are determined by the machine learning system. For instance, if the question is “why is P present in the solution and Q is not”, the auxiliary constraint, enforcing a condition contrary to the premise of that question, is “P is not present in a solution and Q is present in said solution”. In method step 300, the declarative problem solver determines at least one minimal violated set of constraints of the declarative problem encoding based on the declarative problem encoding and, additionally added, the auxiliary constraints, wherein the at least one minimal violated set is inconsistent with the auxiliary constraints. In method step 400, the machine learning system determines an explanation text that constitutes the explanation for the solution based on the at least one minimal violated set.

If the declarative problem solver has determined more than one minimal violated set, the machine learning system determines an explanation for each of the minimal violated sets. In this case the method may further comprise the steps 500 and 600 wherein in optional step 500 user selections of preferred explanations and the corresponding minimal violated sets may be stored in a memory. In optional step 600 similar explanations may be prioritized in future iterations by using the stored selections as additional training data for the machine learning system.

The declarative problem encoding may represent a product configuration problem or a task planning problem for the manufacturing and/or assembly of a product. Accordingly, several solutions of the declarative problem encoding may be determined, wherein the solutions represent valid product configurations, or sequences of actions in the manufacturing or assembly of the product. In such cases, the method may further comprise the steps 700 and 800, which may directly follow step 400, or may follow step 600 above. In step 700, control signal data may be determined based on the solution for product configuration or task planning for the manufacturing and/or assembly of the product selected by a user. The solution may comprise a specific sequence of manufacturing steps and/or a specific combination of components for the product. The control signal data may be control signal data of a machine or manufacturing line, wherein the machine or manufacturing line may be configured for manufacturing/assembling of the product. The product may, for instance, be an electronic component. Particularly, the product may be an electric motor. In step 800, the product may be manufactured/assembled based on the determined control signal data.

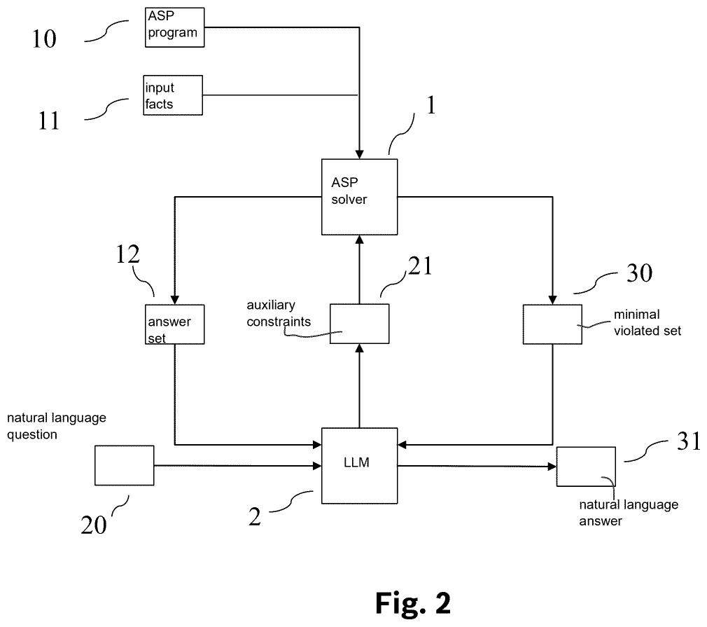

FIG. 2 shows another exemplary embodiment. Exemplarily, this embodiment refers to the case of an answer set programming (ASP) program as special case of a declarative problem encoding.

Generally speaking, ASP is a compact relational, in essence propositional, formalism where variables in the input language are replaced by constant symbols in a preprocessing step, referred to as grounding. An ASP program is a set of rules of the form

$${p}_{1} \vert … \vert {p}_{k} : - {q}_{1} , … , {q}_{m} , not {r}_{1} , … , not {r}_{n} .$$

where all pᵢ, qⱼ, and rₗ are atoms. Generally speaking, an atom in ASP is a basic logical statement that can be true or false, representing a fact or a relationship between entities or terms. The head is all the atoms before the implication symbol :-, and the body is all the atoms and negated atoms afterward. The intuitive meaning of this rule is that if all atoms q₁, . . . , qₘ can be derived and there is no evidence for any of the atoms r₁, . . . , rₙ, then at least one of p₁ . . . , pₖ has to be derived. In other words, the respective rule “fires”, i.e. the rule's conditions are met, and its consequences are activated or applied: the rule takes effect. An interpretation I is a set of atoms. It is an answer-set of a program, if all its rules are satisfied in a minimal and consistent way (doi.org/10.1007/BF03037169). Intuitively, I must be a ⊆-minimal model of all rules that fire. A rule with an empty body is called a fact, with :- usually omitted. Facts are used to express knowledge that is unconditionally true. A rule with empty head is a constraint. The body of a constraint cannot be satisfied by any answer set and is used to prune away unwanted solution candidates. A common syntactic extension are choice rules of the form

$$i \{ {p}_{1} , … , {p}_{k} \} j : - {q}_{1} , … , {q}_{m} , not {r}_{1} , … , not {r}_{n} .$$

The meaning is that if the rule fires, then some subset S of p₁, . . . , pₖ with
i≤|S|≤j has to be true as well.

When used for combinatorial problem solving, ASP programs can usually be split into two components, a guess part enumerating potential solution candidates and a check part pruning the candidates which are not solutions.

With reference to FIG. 2, an ASP program 10 is provided to an ASP solver 1, together with input facts 11. The latter generally may represent the input instance data, whereas the program itself may remain largely fixed for a particular problem. However, in other embodiments, the ASP program or more generally, a declarative problem encoding may already comprise the input facts and these may therefore not be mentioned in addition. The ASP solver is tasked with providing an answer set to the ASP program 10 with the facts 11. If the problem has a solution, the corresponding answer set 12 may be printed and may, subsequently be provided to the machine learning system 2. Machine learning system 2 may be a large language model (LLM). If no solution is found, ASP solver 1 may determine a minimally unsatisfiable set of constraints.

If at least one solution 12, i.e. at least one answer set 12, is determined by ASP solver 1, a user may be asked if he has any questions regarding the answer set 12. The asking may be done via a user interface, such as a monitor, and the question to the user, if he has any question regarding the solution, may be printed on the monitor or may be read to the user. Preferably, user questions regarding the answer set are those questions that are directly contrastive, or “why” questions. It may be noted that for the latter case of “why” questions, a contrast may also be inferred. The user may then input a question 20 in natural language and this natural language question 20 is then passed on to the LLM 2, together with the solution 12. Optionally, the LLM 2 may (implicitly) classify the type of question, using the information provided in an additional custom prompt (i.e., conflict explanation, contrastive explanation or counterfactual explanation). Based on the custom prompt, the LLM may determine auxiliary constraints 21 enforcing a condition contrary to the premise of the natural language question 20.

The custom prompt may additionally comprise several in-context examples, and ASP background. Furthermore the custom prompt tasks LLM 2 to produce auxiliary constraints 21. Auxiliary constraints 21 may also be viewed as assumptions on the truth values of certain atoms. Intuitively, if the user asks “Why P and not Q?”, the auxiliary constraints will enforce a counterfactual where P is false and Q is true. Subsequently, auxiliary constraints 21 are added to the original ASP program 10 (together with facts 11). With the auxiliary constraints added to the original ASP program (with the facts 11), ASP solver 1 is tasked with finding a minimally unsatisfiable set of constraints, i.e. a minimal violated set, 30 for this scenario. The minimal violated set thereby includes only constraints out of the original ASP program 10 (together with facts 11). This implies giving a formal explanation as to why the counterfactual cannot hold. Finally, the LLM 2 is provided with the minimal violated set 30 and prompted to translate the minimal violated set 30 of constraints into a natural language answer 31 that summarizes this information. For this translation, one of at least three alternative approaches can be applied, using LLM 1: direct back-translation into natural language, using a template language to constrain the output, or using controlled natural language to have complete control over the shape of the output.

As a non-limiting, purely illustrative example of a method of explaining a solution of an ASP program, the following input program may be considered, representing the 3-colourability problem with a simple instance of three nodes:
% coloring.lp
% choose a color for each node
{chosenColor(N,C): color(C)}=1 :- node(N).
% adjacent nodes are not allowed to have the same color
:- edge(N1, N2), chosenColor(N1,C), chosenColor(N2,C).
% input
color(red).
color(green).
color(blue).
node(1 . . . 3).
edge(1,2).
edge(1,3).
edge(2, 3).

An example execution of the ASP solver will look as follows:
>python main.py examples/coloring.lp

Answer:
chosenColor(3, red) chosenColor(2, green) chosenColor(1,blue) node(1) node(2) node(3) edge(1,2) edge(1,3) edge(2,3) color(red) color(green) color(blue)

A possible question on the solution may be:
“Why are node 1 and node 2 not both blue?”

A possible explanation could be that node 1 and node 2 are not both blue because there is an edge between them, and adjacent nodes are not allowed to have the same color. In this example, the question “Why are node 1 and node 2 not both blue?” may be reformulated as “Why is node 1 blue and node 2 green in contrast to node 1 blue and node 2 blue?” from which the following assumptions may be generated by the LLM:
:- chosenColor(1,blue), chosenColor(2,green).
:- not chosenColor(1,blue).
:- not chosenColor(2,blue).

The ASP program joined with these assumptions is now inconsistent. The ASP solver is then used to search for a minimal set of constraints from the original program, whose removal restores consistency. In this case, this is achieved by removing an instance of the constraint that expresses that adjacent nodes are not allowed to have the same colour. The LLM finally translates this information into natural language to produce the answer to the initial question.

In order to compute the minimally unsatisfiable set of constraints, one may, for instance, use the following approach. First, the program may be rewritten so that new dummy atoms are added to the head of each constraint. In this way, each set of answers will show which constraints have been violated. Then answer sets may be computed where the dummy atoms are minimal (either subset minimal or cardinality minimal). Those sets may generally be called minimal correction sets. Lastly, a hitting set of all minimal correction sets may be generated, which corresponds to a minimally unsatisfiable set of constraints. This approach to determine the minimally unsatisfiable set of constraints is based on the methods for computing minimal correction sets and minimally unsatisfiable sets described in ceur-ws.org/Vol-3193/paper2ASPOCP.pdf.

What is claimed is:

1. A computer-implemented method of determining an explanation for a solution of a declarative problem encoding determined by a declarative problem solver, the declarative problem encoding including constraints, the method comprising the following steps:
providing the solution and a natural language question regarding a presence or absence of elements within the solution to a machine learning system;
determining, by the machine learning system, auxiliary constraints that enforce a condition contrary to a premise of the natural language question;
determining, by the declarative problem solver, at least one minimal violated set of constraints of the declarative problem encoding based on the auxiliary constraints combined with the declarative problem encoding, wherein the at least one minimal violated set is inconsistent with the auxiliary constraints; and
determining, by the machine learning system, an explanation text that includes the explanation for the solution based on the at least one minimal violated set.

2. The method according to claim 1, wherein the machine learning system is provided with, in addition to the solution and the natural language question, an example natural language question and corresponding example constraints that enforce a condition contrary to a premise of the example natural language question.

3. The method according to claim 1, wherein the natural language question asks:
a) why a first set of elements is present in the solution; or
b) why a second set of elements is not present in the solution; or
c) why a first subset of elements is present in the solution in contrast to a second subset of elements not present.

4. The method according to claim 3, wherein the auxiliary constraints constrain, in a solution of the declarative problem encoding with the auxiliary constraints added:
a) the first set of elements not to be present; or
b) the second set of elements to be present; or
c) the first subset of elements not to be present and the second subset of elements to be present.

5. The method according to claim 1, wherein the machine learning system determines the explanation text in natural language, or in controlled natural language, or in a predefined template language.

6. The method according to claim 1, wherein, when the declarative problem solver determines more than one minimal violated set, the machine learning system determines an explanation for each of the minimal violated sets, and the method further comprises:
storing user selections of preferred explanations and the corresponding minimal violated sets in a memory, and
prioritizing similar explanations in future iterations by using the stored selections as additional training data for the machine learning system.

7. The method according to claim 1, wherein the declarative problem encoding represents: (i) a product configuration problem and/or (ii) a task planning problem for manufacturing of a product and/or (iii) a task planning problem for assembly of the product.

8. The method according to claim 7, wherein several solutions of the declarative problem encoding are determined, wherein the solutions represent valid product configurations, or sequences of actions in the manufacturing or assembly of the product, the method further comprising the steps:
determining, based on the solution of the solutions selected by a user, control signal data of a machine or manufacturing line, wherein the machine or manufacturing line is configured for manufacturing/assembling of the product;
manufacturing/assembling the product based on the determined control signal data.

9. A data processing system, comprising:
a processor configured to perform a method of determining an explanation for a solution of a declarative problem encoding determined by a declarative problem solver, the declarative problem encoding including constraints, the method including the following steps:
providing the solution and a natural language question regarding a presence or absence of elements within the solution to a machine learning system;
determining, by the machine learning system, auxiliary constraints that enforce a condition contrary to a premise of the natural language question;
determining, by the declarative problem solver, at least one minimal violated set of constraints of the declarative problem encoding based on the auxiliary constraints combined with the declarative problem encoding, wherein the at least one minimal violated set is inconsistent with the auxiliary constraints; and
determining, by the machine learning system, an explanation text that includes the explanation for the solution based on the at least one minimal violated set.

10. A non-transitory computer-readable data carrier on which is stored a computer program for determining an explanation for a solution of a declarative problem encoding determined by a declarative problem solver, the declarative problem encoding including constraints, the computer program, when executed by a computer, causing the computer to perform the following steps:
providing the solution and a natural language question regarding a presence or absence of elements within the solution to a machine learning system;
determining, by the machine learning system, auxiliary constraints that enforce a condition contrary to a premise of the natural language question;
determining, by the declarative problem solver, at least one minimal violated set of constraints of the declarative problem encoding based on the auxiliary constraints combined with the declarative problem encoding, wherein the at least one minimal violated set is inconsistent with the auxiliary constraints; and
determining, by the machine learning system, an explanation text that includes the explanation for the solution based on the at least one minimal violated set.
